(19) United States
(12) Patent Application Publication
(10) Pub. No.: US 2017/0316856 A1
(43) Pub. Date: Nov. 2, 2017

(54) COMPACT FOR MAGNET, MAGNETIC MEMBER, METHOD FOR PRODUCING COMPACT FOR MAGNET, AND METHOD FOR PRODUCING MAGNETIC MEMBER

(71) Applicant: Sumitomo Electric Industries, Ltd., Osaka-shi (JP)

(72) Inventors: Kazunari Shimauchi, Itami-shi (JP); Toru Maeda, Itami-shi (JP); Motoi Nagasawa, Itami-shi (JP)

(21) Appl. No.: 15/526,216

(22) PCT Filed: Nov. 2, 2015
(86) PCT No.: PCT/JP2015/080902

§ 371 Date: May 11, 2017

(30) Foreign Application Priority Data
Nov. 11, 2014 (JP) 2014-229352

(51) Int. Cl. H01F 1/059; H01F 7/02; C23C 8/26; C22C 38/00; B22F 9/04; B22F 9/02; B22F 3/03; H01F 41/02; B22F 1/00

(52) U.S. Cl. CPC H01F 1/059; H01F 41/0253; H01F 7/02; C23C 8/26; B22F 1/0011; B22F 9/04; B22F 9/023; B22F 3/03; C22C 38/005

(57) ABSTRACT

There is provided a compact for a magnet which can produce a magnetic member having high coercive force. The compact for a magnet is produced by compression-molding a rare earth-iron-based alloy powder containing a plurality of particles of a rare earth-iron-based alloy containing a rare earth element and iron, wherein the rare earth-iron-based alloy satisfies configurations (a) to (c) below and has 5% by volume or more and 20% by volume or less of voids formed therein. (a) Having a structure containing 10% by mass or more and 30% by mass or less of Sm, 10% by mass or less of Mn, and the balance consisting of Fe and inevitable impurities. (b) A composition, Sm₂MNₓFe₁₇₋ₓ (x=0.1 or more and 2.5 or less). (c) An average crystal grain diameter of 700 nm or less.

### TECHNICAL FIELD

The present invention relates to a compact for a magnet used as a raw material of rare earth magnets used as permanent magnets and the like, a magnetic member produced by nitriding the compact for a magnet, a method for producing a compact for a magnet, and a method for producing a magnetic member. In particular, the present invention relates to a compact for a magnet which can produce a magnetic member having excellent coercive force.

### BACKGROUND ART

Rare earth magnets using rare earth-iron-based alloys each containing a rare earth element and Fe are widely used for applications such as a motor, a generator, etc. A typical example of the rare earth magnets is a Nd-Fe-B-based magnet (neodymium magnet) using a Nd-Fe-B-based alloy. The neodymium magnet is mainly used as a sintered magnet produced by sintering a powder of a rare earth-iron-based alloy and as a bonded magnet producing by solidifying an alloy powder with a binder resin. Besides the neodymium magnet, a Sm-Fe-N-based magnet (samarium-iron-nitrogen magnet) using a Sm-Fe-N-based alloy formed by nitriding a Sm-Fe-based alloy as a raw material is put into practical used. The samarium-iron-nitrogen magnet is generally used as a bonded magnet.

Besides the sintered magnet and the bonded magnet, a compressed powder magnet produced by compression-molding a powder has recently been developed as a rare earth magnet (Patent Literature 1). Patent Literature 1 produces a magnetic member through a preparation step, a granulation step, a molding step, a dehydrogenation step, and a nitriding step and uses the resultant magnetic member as a raw material of a rare earth magnet. In the preparation step, a nano iron powder and a multiphase powder are prepared as a raw material powder. The multiphase powder is produced by hydrogenating (HD: Hydrogenation-Disproportionation) a rare earth-iron-based alloy powder at a temperature equal to or higher than a disproportionation temperature. In the granulation step, a granulated powder is formed by mixing the raw material powder with a binder. In the molding step, a first compact is formed by compression-molding the granulated powder. In the dehydrogenation step, a second compact is formed by dehydrogenating (DR: Desorption-Recombination) the first compact at a temperature equal to or higher than a recombination temperature. In the nitriding step, a composite magnetic member is formed by nitriding the second compact at a temperature equal to or higher than a nitriding temperature in an atmosphere containing a nitrogen element. Patent Literature 1 uses Sm₁(Mn₁Fe₁₁) having an average particle diameter of 30 μm as the rare earth-iron-based alloy powder (para. 0152).

### CITATION LIST

### Patent Literature

PTL 1: Japanese Unexamined Patent Application Publication No. 2012-253247

### SUMMARY OF INVENTION

### Technical Problem

Coercive force is desired to be further improved.

The present invention has been achieved in consideration of the situation described above, and an object of the present invention is to provide a compact for a magnet which can produce a magnetic member having high coercive force.

Another object of the present invention is to provide a magnetic member having high coercive force.

Still another object of the present invention is to provide a method for producing a compact for a magnet which can produce the compact for a magnet.

A further object of the present invention is to provide a method for producing a magnetic member which can produce the magnetic member.

### Solution to Problem

A compact for a magnet according to an aspect of the present invention is a compact for a magnet produced by compression-molding a rare earth-iron-based alloy powder containing a plurality of particles of a rare earth-iron-based alloy containing a rare earth element and iron, the rare earth-iron-based alloy satisfying configurations (a) to (c) below and having 5% by volume or more and 20% by volume or less of voids formed therein.

(a) Having a structure containing 10% by mass or more and 30% by mass or less of Sm, 10% by mass or less of Mn, and the balance consisting of Fe and inevitable impurities

(b) A composition, Sm₂MnₓFe₁₇₋ₓ (x=0.1 or more and 2.5 or less)

(c) An average crystal grain diameter of 700 nm or less

A magnetic member according to an aspect of the present invention is a magnetic member produced by compression-molding a rare earth-iron-nitrogen-based alloy powder containing a plurality of particles of a rare earth-iron-nitrogen-based alloy containing a rare earth element, iron, and nitrogen, the rare earth-iron-nitrogen-based alloy satisfying configurations (a) to (c) below and having 5% by volume or more and 20% by volume or less of voids formed therein.

(a) Having a structure containing 10% by mass or more and 30% by mass or less of Sm, 10% by mass or less of Mn, 2% by mass or more and 7% by mass or less of nitrogen, and the balance consisting of Fe and inevitable impurities

(b) A composition, Sm₂MnₓFe₁₇₋ₓN_{y} (x=0.1 or more and 2.5 or less, y=1.9 or more and 6.8 or less)

(c) An average crystal grain diameter of 700 nm or less

A method for producing a compact for a magnet according to an aspect of the present invention includes a preparation step, a grinding step, a hydrogenation step, a molding step, and a dehydrogenation step. In the preparation step, a rare earth-iron-based alloy flake containing a rare earth element and iron is prepared. In the grinding step, a rare earth-iron-based alloy powder is formed by mechanically grinding the rare earth-iron-based alloy flake in an atmosphere with an oxygen concentration of 1% by volume or less. In the hydrogenation step, a hydrogenated powder is formed by hydrogenating the rare earth-iron-based alloy powder at a temperature equal to or higher than a disproportionation temperature in an atmosphere containing hydrogen. In the molding step, a powder compact is formed by compression-molding the hydrogenated powder under a pressure of 490 MPa or more. In the dehydrogenation step, a compact for a magnet is formed by dehydrogenating the powder compact at a temperature equal to or higher than a recombination temperature in an inert atmosphere or a reduced-pressure atmosphere. The rare earth-iron-based alloy has a structure containing 10% by mass or more and 30% by mass or less of Sm, 10% by mass or less of Mn, and the balance consisting of Fe and inevitable impurities and the composition thereof is Sm₂MnₓFe₁₇₋ₓ (x=0.1 or more and 2.5 or less).

A method for producing a magnetic member according to an aspect of the present invention includes a nitriding step of nitriding a compact for a magnet produced by the method for producing a compact for a magnet described above at a temperature equal to or higher than a nitriding temperature in an atmosphere containing nitrogen.

### Advantageous Effects of Invention

The compact for a magnet can produce a magnetic member having high coercive force.

The magnetic member has high coercive force.

The method for producing a compact for a magnet can produce a compact for a magnet which can produce a magnetic member having high coercive force.

The method for producing a magnetic member can produce a magnetic member having high coercive force.

### DESCRIPTION OF EMBODIMENTS

### <<Description of Embodiment of the Present Invention>>

The inventors have focused on a rare earth-iron-based alloy containing Sm and Fe and earnestly investigated the composition and structure thereof in order to further improve coercive force. As a result, it was found that a rare earth-iron-based alloy satisfying a specified composition ratio and having a specified content of specified element and a crystal structure with a specified size contributes to improvement in coercive force. As a result of further investigation of a compact for a magnet using a powder of the rare earth-iron-based alloy, it was also found that having a specified relative density is particularly effective for improving coercive force. The present invention has been achieved based on these findings. First, embodiments of the present invention are described below.

(1) A compact for a magnet according to an aspect of the present invention is a compact for a magnet produced by compression-molding a rare earth-iron-based alloy powder containing a plurality of particles of a rare earth-iron-based alloy containing a rare earth element and iron, the rare earth-iron-based alloy satisfying configurations (a) to (c) below and having 5% by volume or more and 20% by volume or less of voids formed therein.

(a) Having a structure containing 10% by mass or more and 30% by mass or less of Sm, 10% by mass or less of Mn, and the balance consisting of Fe and inevitable impurities

(b) A composition, Sm₂MnₓFe₁₇₋ₓ (x=0.1 or more and 2.5 or less)

(c) An average crystal grain diameter of 700 nm or less

With the configurations described above, a magnetic member having excellent coercive force can be produced by nitriding the compact. The reasons for this are as follows.

When as in the configurations (a) and (b), the rare earth-iron-based alloy contains a specified amount of Mn, the effect of improving coercive force can be obtained. In particular, when the rare earth-iron-based alloy contains Sm, Mn, and Fe at a specified composition ratio, the effect of improving coercive force can be easily further increased.

When as in the configuration (c), the rare earth-iron-based alloy has an average crystal grain diameter of 700 nm or less, the effect of improving coercive force due to a microcrystal can be expected.

With 5% by volume or more of voids, a magnetic member containing particles of a rare earth-iron-nitrogen-based alloy (Sm₂MnₓFe₁₇₋ₓN_{y}: x=0.1 or more and 2.5 or less, y=1.9 or more and 6.8 or less) having an ideal stoichiometric composition can be easily produced by nitriding the compact for a magnet. A nitrogen flow passage can be easily secured, and thus when the compact for a magnet is nitrided, each of the particles of a rare earth-iron-based alloy (Sm₂MnₓFe₁₇₋ₓ: x=0.1 or more and 2.5 or less) constituting the compact for a magnet can be easily nitrided not only on the surface portion but also in the inside of the compact for a magnet.

With 20% by volume or less of voids, the relative density of the compact for a magnet is not excessively decreased, and thus a decrease in magnetic characteristics due to a density decrease can be easily suppressed.

(2) In an aspect of the compact for a magnet, the oxygen concentration in the rare earth-iron-based alloy is 2500 ppm or less in terms of mass ratio.

The configuration can easily produce a magnetic member having high coercive force. With an oxygen content of 2500 ppm or less, a Sm oxide is little produced, thereby causing a small amount of excessive Fe. Therefore, during nitriding, the production of α-Fe is suppressed, and the magnetic member containing particles of the rare earth-iron-nitrogen-based alloy having an ideal stoichiometric composition can be easily produced by nitriding each of rare earth-iron-based alloy particles.

(3) In an aspect of the compact for a magnet, the thickness of the compact for a magnet is 1 mm or more.

The configuration can easily produce a magnetic member having particles of a rare earth-iron-nitrogen-based alloy having an ideal stoichiometric composition by nitriding each of the rare earth-iron-based alloy particles during nitriding. Even in the compact for a magnet having a thickness of 1 mm or more, when the void ratio is within the specified range described above, nitrogen can be easily penetrated over the inside of the compact for a magnet.

(4) A magnetic member according to an aspect of the present invention is a magnetic member produced by compression-molding a rare earth-iron-nitrogen-based alloy powder containing a plurality of particles of a rare earth-iron-nitrogen-based alloy containing a rare earth element, iron, and nitrogen, the rare earth-iron-nitrogen-based alloy satisfying configurations (a) to (c) below and having 5% by volume or more and 20% by volume or less of voids formed therein.

(a) Having a structure containing 10% by mass or more and 30% by mass or less of Sm, 10% by mass or less of Mn, 2% by mass or more and 7% by mass or less of nitrogen, and the balance consisting of Fe and inevitable impurities

(b) A composition, Sm₂MnₓFe₁₇₋ₓN_{y} (x=0.1 or more and 2.5 or less, y=1.9 or more and 6.8 or less)

(c) An average crystal grain diameter of 700 nm or less

The configurations enable nitriding a compact for a magnet which can easily increase the effect of improving coercive force as described above, thereby causing excellent coercive force.

(5) In an aspect of the magnetic member, the coercive force is 635 kA/m or more.

The configuration causes high coercive force and can be preferably used for a rare earth magnet.

(6) A method for producing a compact for a magnet according to an aspect of the present invention includes a preparation step, a grinding step, a hydrogenation step, a molding step, and a dehydrogenation step. In the preparation step, a rare earth-iron-based alloy flake containing a rare earth element and iron is prepared. In the grinding step, a rare earth-iron-based alloy powder is formed by mechanically grinding the rare earth-iron-based alloy flake in an atmosphere with an oxygen concentration of 1% by volume or less. In the hydrogenation step, a hydrogenated powder is formed by hydrogenating the rare earth-iron-based alloy powder at a temperature equal to or higher than a disproportionation temperature in an atmosphere containing hydrogen. In the molding step, a powder compact is formed by compression-molding the hydrogenated powder under a pressure of 490 MPa or more. In the dehydrogenation step, a compact for a magnet is formed by dehydrogenating the powder compact at a temperature equal to or higher than a recombination temperature in an inert atmosphere or a reduced-pressure atmosphere. The rare earth-iron-based alloy has a structure containing 10% by mass or more and 30% by mass or less of Sm, 10% by mass or less of Mn, and the balance consisting of Fe and inevitable impurities and the composition thereof is Sm₂MnₓFe₁₇₋ₓ (x=0.1 or more and 2.5 or less).

With the configuration, a compact for a magnet which can produce a magnetic member having excellent coercive force can be produced by the preparation step of preparing a rare earth-iron-based alloy flake having a specified content of a specified element and satisfying a specified composition ratio and the molding step of molding under specified pressure.

(7) In an aspect of the method for producing a compact for a magnet, the hydrogenated powder has configurations (a) to (c) described below.

(a) A phase of a Sm hydride and a phase of an iron-containing substance containing Mn and Fe are present adjacent to each other.

(b) The phase of a Sm hydride contains SmH₂ and has a granular shape. (c) The distance between the adjacent Sm hydride phases with the iron-containing substance phase disposed therebetween is 3 μm or less.

With the configuration (a) and the configuration (c), a structure in which the iron-containing substance phase is present between the Sm hydride phases, and both phases are present with the specified distance therebetween is a structure in which both phases are uniformly present. Therefore, when the hydrogenated powder is compression-molded, the particles are uniformly deformed, thereby enhancing moldability. In addition, the expression “distance between the phases of rare earth element hydride” represents the center-to-center distance between adjacent phases of rare earth element hydride in a section. With the configuration (b), moldability can be more enhanced as compared with a layered form in which the phase of rare earth element hydride and the phase of iron-containing substance have a layered structure.

(8) In an aspect of the method for producing a compact for a magnet, the D50 particle diameter of the rare earth-iron-based alloy powder is 50 μm or more and 350 μm or less.

With the configuration, the particle diameter is suitable for compression molding and causes excellent moldability, and thus the compact for a magnet having a void ratio within the specified range described above can be easily produced. Also, the size makes oxidation difficult, and thus the compact for a magnet having an oxygen content within the specified range described above can be easily produced.

(9) A method for producing a magnetic member according to an aspect of the present invention includes a nitriding step of nitriding a compact for a magnet produced by the method for producing a compact for a magnet described above in any one of (6) to (8) at a temperature equal to or higher than a nitriding temperature in an atmosphere containing nitrogen.

With the configuration, a magnetic member having high coercive force can be produced. This is because as described above, the compact for a magnet to be nitrided contains a rare earth-iron-based alloy having a specified composition and a specified average crystal grain diameter and has voids formed therein at a specified void ratio. Therefore, Sm₂MnₓFe₁₇₋ₓN_{y} (x=0.1 or more and 2.5 or less, y=1.9 or more and 6.8 or less) can be easily formed by nitriding Sm₂MnₓFe₁₇₋ₓ (x=0.1 or more and 2.5 or less).

(10) In an aspect of the method for producing a magnetic member, the atmosphere containing nitrogen is any one of a NH₃ gas atmosphere, an atmosphere of mixed gas of NH₃ gas and H₂ gas, a N₂ gas atmosphere, and an atmosphere of mixed gas of N₂ gas and H₂ gas.

With the configuration, Sm₂MnₓFe₁₇₋ₓN_{y} (x=0.1 or more and 2.5 or less, y =1.9 or more and 6.8 or less) can be easily formed.

(11) In an aspect of the method for producing a magnetic member, nitriding is performed at a temperature of 300° C. or more and 550° C. or less for a retention time of 10 min or more and 2000 min or less.

With the configuration, nitriding is easily accelerated, and thus Sm₂MnₓFe₁₇₋ₓN_{y} (x=0.1 or more and 2.5 or less, y=1.9 or more and 6.8 or less) can be easily formed.

### <<Details of Embodiments of the Present Invention>>

Details of embodiments of the present invention are described. The present invention is not limited to these embodiments and is defined by claims and aimed at including meanings equivalent to the scope of the claims and all changes within the scope.

### Embodiment 1

[Compact for Magnet]

A compact for a magnet according to embodiment 1 is produced by compression-molding a rare earth-iron-based alloy powder containing a plurality of particles of a rare earth-iron-based alloy containing a rare earth element and iron. The compact for a magnet is mainly characterized in that the rare earth-iron-based alloy contains a specified element, satisfies a specified composition ratio, and has a crystal structure with a specified size. Thus, a magnetic member having excellent coercive force can be produced. This is described in detail below.

(Composition)

The rare earth-iron-based alloy contains a rare earth-iron-based compound composed of samarium (Sm) and the balance including an iron-containing element containing manganese (Mn) and iron (Fe). Mn is present to be substituted by a part of Fe. The rare earth-iron-based allow is allowed to contain inevitable impurities. The content of Sm in the rare earth-iron-based compound is preferably 10% by mass or more and 30% by mass or less and more preferably 24% by mass or more and 26.5% by mass or less. The content of Mn in the rare earth-iron-based compound is 10% by mass or less. The content of Mn is 1% by mass or more and preferably 2% by mass or more and 8% by mass or less. The content of Fe in the rare earth-iron-based compound is the balance. A specified example of the composition of the rare earth-iron-based compound is Sm₂MnₓFe₁₇₋ₓ (x=0.1 or more and 2.5 or less).

(Average Crystal Grain Diameter)

The average crystal grain diameter of the rare earth-iron-based alloy is 700 nm or less. When the average crystal grain diameter is as fine as 700 nm or less, the effect of enhancing magnetic characteristics (particularly, coercive force) due to a microcrystal structure can be expected. As the average crystal gain diameter decreases, it becomes nearer to the critical diameter of magnetic single-domain particles and the magnetic characteristics are more excellent. The average crystal grain diameter is preferably 500 nm or less and more preferably 300 nm or less. The average crystal grain diameter is measured as follows. A surface or section (observation surface) of the rare earth-iron-based alloy is observed with a scanning electron microscope (SEM), the area of each of crystal grains is determined from an observed image, and an average of equivalent circle diameters of the areas is considered as the average crystal grain diameter. Calculation using the observed image can be easily made by using a commercial image processing software.

(Oxygen Content)

The oxygen content in the rare earth-iron-based alloy is preferably as low as possible. This is because the lower the oxygen content, the more easily a magnetic member having particles of a rare earth-iron-nitrogen-based alloy (Sm₂MnₓFe₁₇₋ₓN_{y}, x=0.1 or more and 2.5 or less, y=1.9 or more and 6.8 or less) having an ideal stoichiometric composition can be formed by nitriding (described below) the compact for a magnet. The oxygen content is preferably 2500 ppm or less in terms of mass ratio. When the oxygen content is as low as 2500 ppm or less, the effect of improving coercive force can be easily enhanced. The oxygen content in terms of mass ratio is preferably 2000 ppm or less, more preferably 1700 ppm, still more preferably 1400 ppm, and particularly preferably 1000 ppm. The oxygen content can be determined by an inert-gas melting-nondispersive infrared absorption method (NDIR).

(Average Particle Diameter)

The average particle diameter of the rare earth-iron-based alloy particles is preferably 50 μm or more and 350 μm or less. With the particle diameter within the range described above, a predetermined void ratio can be easily attained. Also, oxidative deterioration in magnetic characteristics can be easily suppressed. The average particle diameter is particularly preferably 75 μm or more and 250 μm or less. The average particle diameter can be measured by taking a sectional image using SEM and analyzing the image by using a commercial image analysis software. In this case, an equivalent circle diameter is regarded as the particle diameter of an alloy particle. The equivalent circle diameter is the diameter of a circle having the same area as area S surrounded by the specified outline of a particle. That is, the equivalent circle diameter is represented by the equivalent circle diameter=2×{area S in the outline/π}^{1/2}. The average particle diameter results from maintenance of the average particle diameter D50 of a rare earth-iron-based alloy powder formed in a grinding step described below.

(Void Ratio)

The void ratio of the compact for a magnet is 5% by volume or more and 20% by volume or less. With the void ratio of 5% by volume or more, the magnetic member containing particles of the rare earth-iron-nitrogen-based alloy (Sm₂MnₓFe₁₇₋ₓN_{y}, x=0.1 or more and 2.5 or less, y=1.9 or more and 6.8 or less) having an ideal stoichiometric composition can be easily formed by nitriding (described below) the compact for a magnet. This s because a nitrogen flow passage can be secured up to the inside of the compact for a magnet, and thus when the magnetic member is formed by nitriding (described below) the compact for a magnet, each of the particles of the rare earth-iron-based alloy (Sm₂MnₓFe₁₇₋ₓ, x=0.1 or more and 2.5 or less) constituting the compact for a magnet can be easily nitrided. With the void ratio of 20% by volume or less, the relative density of the compact for a magnet is not excessively decreased, and a decrease in magnetic characteristics due to a decrease in the density can be easily suppressed. The void ratio can be determined according to “100−[Relative density of compact for magnet]”. The relative density represents an actual density relative to true density (percentage of [apparent density of compact for magnet/true density of compact for magnet]).

(Size)

The thickness of the compact for a magnet can be properly selected according to the desired thickness of the magnetic member. The thickness of the compact for a magnet can be controlled to be, for example, 1 mm or more. Even when the compact for a magnet has a thickness of 1 mm or more, the magnetic member containing particles of the rare earth-iron-nitrogen-based alloy (Sm₂MnₓFe₁₇₋ₓN_{y}, x=0.1 or more and 2.5 or less, y=1.9 or more and 6.8 or less) having an ideal stoichiometric composition can be easily formed by nitriding. This is because having the predetermined void ratio described above makes it easy to secure a nitrogen flow passage. The thickness of the compact for a magnet can be controlled to be 0.5 mm or more, further 1 mm or more, and particularly 5 mm or more. The thickness is practically about 100 mm or less, further 70 mm or less, and particularly 50 mm or less.

[Method for Producing Compact for Magnet]

A method for producing a compact for a magnet includes a preparation step, a grinding step, a hydrogenation step, a molding step, and a dehydrogenation step. Each of the steps is described sequentially in detail below.

(Preparation Step)

In the preparation step, a rare earth-iron-based alloy flake is prepared. The rare earth-iron-based alloy contains the same rare earth-iron-based compound as described above. That is, the composition of the rare earth-iron-based alloy has a structure containing 10% by mass or more and 30% by mass or less of Sm, 10% by mass or less of Mn, and the balance consisting of Fe and inevitable impurities, and the composition is Sm₂MnₓFe₁₇₋ₓ (x=0.1 or more and 2.5 or less).

The thickness of the rare earth-iron-based alloy flake is preferably 1 mm or less, and the maximum length is preferably 100 μm or more and 50 mm or less. With the thickness of 1 mm or less and the maximum length of 100 μm or more, the particles can be easily ground to a predetermined particle diameter in the subsequent grinding step, and a powder for a magnet having a particle diameter (50 μm or more and 350 μm or less) suitable for compression molding can be easily produced. With the maximum length of 50 mm or less, the time required for the subsequent grinding step can be shortened. The term “maximum length” represents the length of a longest portion of the rare earth-iron-based alloy flake as viewed in a plane of the rare earth-iron-based alloy flake in the thickness direction.

A method for producing the rare earth-iron-based alloy flake is not particularly limited, and the rare earth-iron-based alloy flake can be produced by, for example, a rapid solidification method or the like. The rare earth-iron-based alloy flake is preferably produced by a strip casting method which is the rapid solidification method because the alloy flake with the size described above can be easily produced.

(Grinding Step)

In the grinding step, a rare earth-iron-based alloy powder is formed by mechanically grinding the rare earth-iron-based alloy flake. The particle diameter of the rare earth-iron-based alloy powder is controlled to be a desired particle diameter by grinding. In the grinding step, the particle diameter of particles of the rare earth-iron-based alloy powder can be easily controlled by mechanical grinding. Specifically, the rare earth-iron-based alloy flake is ground to a specified particle diameter to produce the rare earth-iron-based alloy powder having a particle diameter (D50 of 50 μm or more and 350 μm or less) suitable for compression molding. With D50 within the range described above, a powder compact having a predetermined void ratio can be easily formed. Also, oxidation can be easily suppressed, and deterioration in magnetic characteristics can be easily suppressed. The D50 (50 volume % particle diameter) represents the particle diameter value at accumulation of 50% from the small diameter side in a volume-based particle size distribution measured by a laser diffraction particle size distribution analyzer.

An apparatus for grinding the rare earth-iron-based alloy flake is, for example, a milling grinder or an impact grinder. Typical examples of the milling grinder include a Braun mill and the like, and typical examples of the impact grinder include a pin mill and the like. These apparatuses are suitable for grinding the rare earth-iron-based alloy flake to the predetermined particle diameter, and the particle diameter can be easily controlled.

The atmosphere for grinding preferably has an oxygen concentration of 1% by volume or less in terms of volume ratio in order to suppress the oxidation of the rare earth-iron-based alloy flake (rare earth-iron-based alloy powder). In this case, oxidation of Sm is easily suppressed. Therefore, the production of α-Fe due to remaining Fe is easily suppressed in subsequent dehydrogenation (described below). This is because when a Sm oxide is produced, the Sm oxide remains later and thus decreases an amount of Sm to be bonded to Fe. Therefore, the production of the Sm oxide and α-Fe is easily suppressed, and thus diffusion of nitrogen is accelerated in subsequent nitriding (described below), thereby easily suppressing a decrease in coercive force. By controlling the atmosphere, the oxygen content in a hydrogenated powder described below can be controlled to be 2000 ppm or less in terms of mass ratio, and the oxygen content in the rare earth-iron-based alloy of the compact for a magnet can be controlled to be 2500 ppm or less in terms of mass ratio as described above. The oxygen content in the atmosphere is more preferably 0.5% or less in terms of volume ratio. An example of the atmosphere is an inert atmosphere (Ar atmosphere or nitrogen atmosphere) or a reduced-pressure atmosphere (vacuum atmosphere at 10 Pa or less).

(Hydrogenation Step)

In the hydrogenation step, a hydrogenated powder is formed by hydrogenating the rare earth-iron-based alloy powder at a temperature equal to or higher than a disproportionation temperature in an atmosphere containing hydrogen.

The hydrogenated powder contains the rare earth-iron-based compound having a structure which is decomposed into a phase of a rare earth element hydride and a phase of an iron-containing substance containing iron. Examples of the rare earth element hydride include SmH₂. Examples of the phase of the iron-containing substance include only a phase of an iron compound such as Mn-Fe in which Fe is partially substituted by Mn, a phase containing both a phase of the iron compound and a phase of pure iron (Fe), and a mixed phase containing a phase of the iron compound, a phase of pure iron (Fe), and a phase of pure manganese (Mn). The hydrogenated powder contains the rare earth-iron-based compound before phase decomposition and pure iron (Fe) and the iron compound (Mn-Fe) which are soft portions softer than the phase of the rare earth element hydride, and thus moldability can be enhanced by deformation during compression molding.

An example of a form in which the phase of the rare earth element hydride and the phase of the iron-containing substance are present is a dispersed form in which the phase of granular rare earth element hydride is present to be dispersed in the phase of the iron-containing substrate. In the dispersed form, the phase of the iron-containing substance is uniformly present around the phase of the rare earth element hydride, thereby easily enhancing moldability. Therefore, the power compact having a complicated shape such as a circular-arc shape, a cylindrical shape, a columnar shape, or a pot-like shape can be easily formed. The form of presence can be controlled by heat-treatment conditions (mainly, temperature) of the hydrogenation described below.

Each of the particles of the hydrogenated powder preferably has a structure having 10% by volume or more and less than 40% by volume of the phase of the rare earth element hydride and the balance including the phase of the iron-containing substance containing Mn and Fe. The balance excluding the phase of the rare earth element hydride substantially includes the phase of the iron-containing substance, and when the phase of the iron-containing substance is a main component (60% by volume or more and 90% by volume or less), moldability of the compact for a magnet can be easily enhanced. The phase of the rare earth element hydride and the phase of the iron-containing substance are present adjacent to each other, and the distance between the adjacent phases of the rare earth element hydride with the phase of the iron-containing substance disposed therebetween is preferably 3 μm or less. The structure in which the phase of the iron-containing substance is present between the phases of the rare earth element hydride and both phases are present at the specified distance described above is a structure in which both phases are uniformly present, thereby causing uniform deformation by compression molding.

The distance can be measured by removing the phase of the iron-containing substance by etching a section and extracting the phase of the rare earth element hydride, by removing the phase of the rare earth element hydride and extracting the phase of the iron-containing substance depending to the type of the solution used, or by analyzing a composition of a section by EDX (energy dispersive X-ray spectrometry). With the distance of 3 μm or less, when the phase of the rare earth element hydride and the phase of the iron-containing substance are recombined to form the original rare earth-iron-based compound by subsequent dehydrogenation, excessive energy need not be applied, and a decrease in characteristics due to coarsening of crystal grains of the rare earth-iron-based compound can be suppressed. In order that the phase of the iron-containing substance is sufficiently present between the phases of the rare earth element hydride, the distance is preferably 0.5 μm or more and 3 μm or less and more preferably 1 μm or more and 3 μm or less. The distance can be controlled by adjusting the composition of the rare earth-iron-based alloy used as a raw material or adjusting the conditions, particularly heat treatment temperature, for hydrogenation. For example, when the iron ratio (atomic ratio) in the rare earth-iron-based alloy is increased or when the heat treatment temperature is increased within the temperature range described above, the distance tends to be increased.

The hydrogenated powder preferably has a low oxygen content. With the lower oxygen content, as described above, the oxygen content in the rare earth-iron-based alloy of the compact for a magnet can be controlled to be 2500 pp or less in terms of mass ratio, and the magnetic member having high coercive force can be easily produced. The oxygen content in terms of mass ratio is preferably 2000 ppm or less, more preferably 1700 ppm or less, still more preferably 1400 ppm or less, and particularly preferably 1000 ppm or less. The oxygen content can be determined by an inert-gas melting-nondispersive infrared absorption method (NDIR).

Examples of the hydrogenation conditions include an atmosphere such as a H₂ gas atmosphere or a mixed gas atmosphere containing H₂ gas and inert gas such as Ar or N₂, a temperature equal to or higher than the hydrogenation-disproportionation temperature (for example, 600° C. or more and 1000° C. or less depending on the material used) of the prepared alloy, and a retention time of 30 minutes or more and 300 minutes or less. When the heat treatment temperature is set to be a high temperature 100° C. or more higher than the disproportionation temperature, the form of both phases present becomes the dispersed form described above.

(Molding Step)

In the molding step, a powder compact is formed by compression-molding the hydrogenated powder. Molding may be performed by using a mold having a desired shape.

The molding pressure for the hydrogenated powder is, for example, 490 MPa or more. When the molding pressure is, for example, 490 MPa or more, the relative density of the powder compact can be increased. The molding pressure is, for example, 1500 MPa or less. When the molding pressure is 1500 MPa or less, the relative density of the powder compact is not excessively increased, and the void ratio is not excessively decreased. That is, when the magnetic member is formed by nitriding the formed compact for a magnet, a nitrogen flow passage is easily secured, and each of the particles constituting the powder compact is easily nitrided. Therefore, the magnetic member containing particles of the rare earth-iron-nitrogen-based alloy (Sm₂MnₓFe₁₇₋ₓN_{y}, x=0.1 or more and 2.5 or less, y=1.9 or more and 6.8 or less) having an ideal stoichiometric composition can be easily formed. The molding pressure is preferably 600 MPa or more and 1400 MPa or less and particularly preferably 700 MPa or more and 1300 MPa or less.

The atmosphere of compression molding is preferably a low-oxygen atmosphere in order to suppress oxidation of the hydrogenated powder (powder compact). For example, like in the grinding step, preferred is an inert atmosphere (Ar atmosphere or nitrogen atmosphere) having an oxygen concentration of 1% or less, further 0.5% or less, in terms of volume ratio or a reduced-pressure atmosphere (vacuum atmosphere at 10 Pa or less).

(Dehydrogenation Step)

In the dehydrogenation step, the compact for a magnet is formed by heat-treatment dehydrogenating the powder compact at a temperature equal to or higher than a recombination temperature in an inert atmosphere or a reduced-pressure atmosphere. The hydrogenated powder constituting the powder compact has a state which is decomposed, by hydrogenation, into the phase of the rare earth element hydride and the phase of the iron-containing substance and is recombined to the initial rare-earth-iron-based compound by dehydrogenation.

Examples of the conditions for dehydrogenation include an atmosphere, for example, a non-hydrogen atmosphere (atmosphere of inert gas such as Ar or N₂, or a reduced-pressure atmosphere (for example, vacuum atmosphere under pressure lower than the standard atmospheric pressure), a temperature equal to or higher than the recombination temperature of the hydrogenated alloy (for example, 600° C. or more and 1000° C. or less depending on the material), and a retention time of 10 minutes or more and 600 minute or less. In particular, the reduced-pressure atmosphere (for example, a degree of vacuum of 100 Pa or less, a final degree of vacuum of 10 Pa or less, further 1 Pa or less) is preferred because the rare earth element hydride hardly remains. At the temperature, the crystal growth of the recombined alloy is suppressed, thereby producing a microcrystal structure (for example, an average crystal grain diameter of 700 nm or less).

[Magnetic member]

The magnetic member is produced by nitriding the compact or a magnet or a compact for a magnet produced by the method for producing a compact for a magnet to convert the rare earth-iron-based alloy constituting the compact for a magnet to the rare earth-iron-nitrogen-based alloy. The content of each of Sm and Mn in the rare earth-iron-nitrogen-based alloy results from substantial maintenance of the content of each of Sm and Mn in the compact for a magnet. The nitrogen content in the rare earth-iron-nitrogen-based alloy is 2% by mass or more and 7% by mass or less. The nitrogen content is preferably 2.5% by mass or more and 6.5% by mass or less. The Fe content in the rare earth-iron-nitrogen-based alloy is the balance. An example of the composition of the rare earth-iron-nitrogen-based alloy is Sm₂MnₓFe₁₇₋ₓN_{y} (x=0.1 or more and 2.5 or less, y=1.9 or more and 6.8 or less). The average crystal grain diameter of the rare earth-iron-nitrogen-based alloy results from substantial maintenance of the average crystal grain diameter of the rare earth-iron-based alloy in the compact for a magnet, that is, 700 nm or less. The void ratio of the magnetic member results from substantial maintenance of the void ratio of the compact for a magnet, that is, 5% by volume or more and 20% by volume or less.

The coercive force of the magnetic member is preferably 635 kA/m or more. Thus, the magnetic member can be preferably used for a rare earth magnet. The coercive force is preferably 650 kA/m or more, more preferably 700 kA/m or more, 770 kA/m or more, 850 kA/m or more, or 930 kA/m or more, and particularly preferably 1000 kA/m or more. A rare earth magnet can be produced by magnetizing the magnetic member.

[Method for Producing Magnetic Member]

The magnetic member can be produced by nitriding the compact or a magnet or a compact for a magnet produced by the method for producing a compact for a magnet.

[Nitriding Step]

In the nitriding step, the magnetic member is formed by heat-treatment nitriding the compact for a magnet at a temperature equal to or higher than a nitriding temperature in a nitrogen-containing atmosphere. The nitrogen-containing atmosphere is an atmosphere containing nitrogen element and is, for example, an atmosphere containing at least one of nitrogen (N₂) and ammonia (NH₃) as described below. The particles of a Sm-Fe-based alloy (Sm₂MnₓFe₁₇₋ₓ: x=0.1 or more and 2.5 or less) constituting the compact for a magnet can be converted, by nitriding, to the particles of a Sm-Fe-N-based alloy (Sm₂MnₓFe₁₇₋ₓN_{y}: x=0.1 or more and 2.5 or less, y=1.9 or more and 6.8 or less).

Examples of the nitriding conditions include a nitrogen-containing atmosphere such as a NH₃ gas atmosphere, a mixed gas atmosphere containing NH₃ gas and H₂ gas, a N₂ gas atmosphere, or a mixed gas atmosphere of N₂ gas and H₂ gas, a temperature of 300° C. or more and 550° C. or less and preferably 320° C. or more and 450° C. or less, and a retention time of 10 minutes or more and 2000 minutes or less, preferably 30 minutes or more and 2000 minutes or less, and particularly preferably 60 minutes or more and 1800 minutes or less.

The nitriding can be performed with a magnetic field applied. With the magnetic field applied, a crystal lattice is easily stretched in one direction, and a nitrogen atom is preferentially inserted into the stretched space between iron atoms, thereby easily producing the magnetic member containing particles of the rare earth-iron-nitrogen-based alloy (for example, Sm₂MnₓFe₁₇₋ₓN_{y}, x=0.1 or more and 2.5 or less, y=1.9 or more and 6.8 or less) having an ideal stoichiometric composition. The magnitude of the magnetic field applied is, for example, 3 T or more.

[Function and Effect]

According to the embodiments described above, the following effects can be exhibited.

(1) A magnetic member having high coercive force can be produced by nitriding a compact for a magnet.

(2) Nitriding of the compact for a magnet produces a rare earth-iron-nitrogen-based alloy having a wide range of nitrogen contents (composition ratio) which can take a high value of coercive force. Therefore, even if unevenness occurs in nitriding of alloy particles constituting the compact for a magnet, the magnetic member having high coercive force can be easily produced, and thus variation in coercive force can be easily suppressed.

(3) The method for producing a compact for a magnet includes preparing a Sm-Mn-Fe ally flake having a specified amount of Mn and a specified composition ratio, grinding the flake, and then compression-molding the resultant powder under specified pressure, and thus can produce a compact for a magnet which can produce a magnetic member having high coercive force.

(4) The magnetic member has high coercive force and thus can be preferably used for a rare earth magnet.

(5) The method for producing a magnetic member can produce a magnetic member having high coercive force.

[Test Example 1 ]

Sample Nos. 1-1 to 1-13 of a compact for a magnet were formed, and then a magnetic member was formed by using each of the samples, followed by evaluation of magnetic characteristics of each of the sample.

[Sample Nos. 1-1 to 1-13]

Each of sample Nos. 1-1 to 1-13 of a compact for a magnet was formed according to the procedures including a preparation step, a grinding step, a hydrogenation step, a molding step, and a dehydrogenation step.

First, a Sm-Fe-based alloy flake having a thickness of 1 mm or less and each of compositions a to d was prepared as a raw material.

a: 24.3% by mass Sm-balance consisting of Fe and inevitable impurities

b: 24.3% by mass Sm-3.7% by mass Mn-balance consisting of Fe and inevitable impurities

c: 24.3% by mass Sm-7.5% by mass Mn-balance consisting of Fe and inevitable impurities

d: 24.3% by mass Sm-11% by mass Mn-balance consisting of Fe and inevitable impurities

The content of each of the elements in the alloy flake was measured by ICP (Inductively Coupled Plasma) emission spectroscopy. As a result of calculation of the composition ratio using the measured content of each of the elements, the composition was found to be Sm₂MnₓFe₁₇₋ₓ. The value of ratio x of Mn is shown in Table 1.

Next, a Sm-Fe-based alloy powder was formed by grinding the Sm-Fe-based alloy flake. The grinding was performed by using a cemented carbide-made mortar in a glove box in which the oxygen concentration was adjusted. Table 1 shows the oxygen concentration (ppm) in terms of volume ratio in each of the samples in the glove box. As a result of measurement of a volume-based particle size distribution of the resultant hydrogenated powder by using a laser diffraction particle size distribution analyzer, D50 was 100 μm.

Next, a hydrogenated powder was formed by hydrogenating the Sm-Fe-based alloy powder. Hydrogenation was performed by using a vacuum heat treatment furnace under the conditions of 850° C. and 3 hours in a hydrogen atmosphere. The oxygen content (ppm) in terms of mass ratio in the hydrogenated powder was measured by an inert gas melting-nondispersive infrared absorption method (NDIR). The results are shown in Table 1.

The structure of the hydrogenated powder was measured by EDX. As a result, the hydrogenated powder produced by using the Sm-Fe-based alloy flake having each of the composition b and composition c was confirmed to have the following features.

(a) Having a structure having 10% by volume or more and less than 40% by volume of a phase of Sm hydride and the balance including a phase of an iron-containing substance containing Mn and iron.

(b) The phase of Sm hydride has a granular shape and is present in the form of being dispersed in the phase of the iron-containing substance.

(c) The phase of Sm hydride and the phase of the iron-containing substance are present adjacent to each other, and the distance between the adjacent phases of the rare earth element hydride with the phase of the iron-containing substance disposed therebetween is 3 μm or less.

Next, a mold was filled with the hydrogenated powder, and a cylindrical powder compact having a diameter of about 10 mm and a height of about 10 mm was formed by compression molding. Compression molding was performed in a vacuum atmosphere under the molding pressure shown in Table 1.

Next, a compact for a magnet was produced by dehydrogenating the powder compact. The dehydrogenation was performed in the vacuum heat-treatment furnace in which the hydrogen atmosphere was changed to the vacuum atmosphere under the conditions of 800° C. and 3 hours in a vacuum atmosphere. The degree of vacuum of the vacuum atmosphere was set to be less than 0.5 Pa.

[Measurement of Relative Density]

The density and void ratio of the compact for a magnet of each of the samples were measured. The apparent density of the compact for a magnet was calculated from the size and mass. The void ratio was calculated according to “100 -Relative density”. The relative density was determined from a percentage of “apparent density of compact for magnet/true density of compact for magnet”. The density and void ratio of each of the samples are shown in Table 1.

[Measurement of Average Crystal Grain Diameter]

The average crystal grain diameter of the Sm-Fe-based alloy constituting the compact for a magnet was measured as follows. A surface or section (observation surface) of the compact for a magnet observed with a scanning electron microscope (SEM), the area of each of crystal grains was determined from an observed image by using a commercial image processing software, and an average of equivalent circle diameters of the areas was considered as the average crystal grain diameter. The results are shown in Table 1.

[Measurement of Oxygen Content]

The oxygen content (ppm) in terms of mass ratio of the compact for a magnet was measured by an inert-gas melting-nondispersive infrared absorption method (NDIR). The results are shown in Table 1.

[Evaluation of Magnetic Characteristics]

A magnetic member was formed by nitriding the compact for a magnet, and the magnetic characteristics of the magnetic member were examined by magnetizing the magnetic member with a pulsed magnetic field of 3.5 T. The nitriding was performed at 400° C. for 10 hours in an atmosphere of mixed gas with NH₃:H₂=1:3. The nitrogen content (% by mass) of the magnetic member was measured by the inert gas melting-thermal conductivity method (TCD). As a result of calculation of a composition ratio from the measured results, the composition was found to be Sm₂MnₓFe₁₇₋ₓN_{y}. The ratio y of N is shown in Table 1. The ratio x of Mn is the same as the value calculated in the preparation step. With respect to the magnetic characteristics of the magnetic member, the coercive force (kA/m) was examined by using a BH tracer (DCBH tracer manufactured by Riken Denshi Co., Ltd.). The results are shown in Table 1.

TABLE 1

| | | | Grinding | | | Compact for magnet | | | | | |
|---|---|---|---|---|---|---|---|---|---|---|---|
| | | | step | Hydrogenated | Molding | | Void | Average | | Magnetic | |
| | | | Oxygen | powder | step | | ratio | crystal | | member | |
| | Composition | | concen- | Oxygen | Molding | | % by | grain | Oxygen | Ratio | Coercive |
| Sample | | Ratio x | tration | content | pressure | Density | vol- | diameter | content | y of | force |
| No. | Type | of Mn | ppm | ppm | MPa | g/cm³ | ume | nm | ppm | N | kA/m |
| 1-1 | a | 0 | 18000 | 2300 | 980 | 6.52 | 16.3 | 500 | 2900 | 1.7 | 155.2 |
| 1-2 | a | 0 | 4000 | 1500 | 980 | 6.51 | 16.4 | 500 | 1800 | 1.8 | 508.5 |
| 1-3 | a | 0 | 3500 | 1200 | 980 | 6.53 | 16.2 | 500 | 1500 | 1.9 | 523.6 |
| 1-4 | b | 0.9 | 18000 | 2200 | 980 | 6.53 | 16.2 | 500 | 2700 | 2.1 | 596.3 |
| 1-5 | b | 0.9 | 4000 | 1400 | 980 | 6.54 | 16.1 | 500 | 1800 | 2.9 | 1097 |
| 1-6 | b | 0.9 | 3500 | 1100 | 980 | 6.53 | 16.2 | 500 | 1600 | 3.1 | 1120 |
| 1-7 | c | 1.85 | 4000 | 1400 | 980 | 6.52 | 16.3 | 500 | 1700 | 3.3 | 1013 |
| 1-8 | d | 2.7 | 4000 | 1400 | 980 | 6.52 | 16.3 | 500 | 1700 | 3.5 | 496.6 |
| 1-9 | b | 0.9 | 4000 | 1400 | 441 | 6.09 | 21.8 | 500 | 1800 | 3.1 | 608.8 |
| 1-10 | b | 0.9 | 4000 | 1500 | 2451 | 7.52 | 3.5 | 700 | 1900 | 1.1 | 188.6 |
| 1-11 | b | 0.9 | 4000 | 1500 | 980 | 6.53 | 16.2 | 900 | 1800 | 3.0 | 538.7 |
| 1-12 | b | 0.9 | 4000 | 1400 | 980 | 6.54 | 16.1 | 700 | 1700 | 3.1 | 957.3 |
| 1-13 | b | 0.9 | 4000 | 1400 | 980 | 6.53 | 16.2 | 300 | 1900 | 3.1 | 1132 |

It is found that each of sample Nos. 1-5 to 1-7, 1-12, and 1-13 containing over 0% by mass and 10% by mass or less of Mn and having a composition satisfying Sm₂MnₓFe₁₇₋ₓ (x=0.1 or more and 2.5 or less), a structure having an average crystal grain diameter of 700 nm or less, and a void ratio of 5% by volume or more and 20% by volume or less has a coercive force of 635 kA/m or more and thus has high coercive force. In particular, comparison between sample Nos. 1-5 and 1-7 indicates that sample No. 1-5 having a lower Mn content and a lower ratio x of Mn has higher coercive force. Further, comparison between sample No. 1-5 and sample Nos. 1-12 and 1-13 indicates that the coercive force increases as the average crystal grain diameter decreases. Further, sample No. 1-5 and sample No. 1-6 using a hydrogenated powder having an oxygen content of 2000 ppm or less have high coercive force, and comparison between sample Nos. 1-5 and 1-6 indicates that particularly, sample No. 1-6 having a lower oxygen content has even higher coercive force. The compact for a magnet of each of sample Nos. 1-5 to 1-7 and sample Nos. 1-12 and 1-13 has an oxygen content (ppm) of 2500 ppm or less in terms of mass ratio of each particle.

The void ratio of each of the magnetic members of sample Nos. 1-5 to 1-7 and sample Nos. 1-12 and 1-13 was measured by the same method as measurement of the void ratio of the compact for a magnet. As a result, the void ratio of each of the compacts for a magnet was substantially maintained. The composition of the Sm-Fe-N-based alloy constituting the magnetic member was Sm₂MnₓFe₁₇₋ₓN_{y} (x=0.1 or more and 2.5 or less, y=1.9 or more and 6.8 or less). As a result of measurement of the average crystal grain diameter of the Sm-Fe-N-based alloy by the same method as measurement of the average crystal grain diameter of the Sm-Fe-based alloy, the average crystal grain diameter of each of the compacts of a magnet was substantially maintained.

### INDUSTRIAL APPLICABILITY

A compact for a magnet of the present invention and a magnetic member produced by using the compact for a magnet can be preferably used as a raw material for permanent magnets, for example, permanent magnets used for various motors, particularly high-speed motors provided on a hybrid car, a hard disk drive, and the like. A method for producing a compact for a magnet and a method for producing a magnetic member of the present invention can be preferably used for producing a raw material of a rare earth magnet used as a permanent magnet or the like.

1. A compact for a magnet produced by compression-molding a rare earth-iron-based alloy powder containing a plurality of particles of a rare earth-iron-based alloy containing a rare earth element and iron,
wherein the rare earth-iron-based alloy satisfies configurations (a) to (c) below and has 5% by volume or more and 20% by volume or less of voids formed therein:
(a) having a structure containing 10% by mass or more and 30% by mass or less of Sm, 10% by mass or less of Mn, and the balance consisting of Fe and inevitable impurities;
(b) a composition, Sm₂MnₓFe₁₇₋ₓ (x=0.1 or more and 2.5 or less); and
(c) an average crystal grain diameter of 700 nm or less.

2. The compact for a magnet according to claim 1, wherein the oxygen concentration in the rare earth-iron-based alloy is 2500 ppm or less in terms of mass ratio.

3. The compact for a magnet according to claim 1, wherein the thickness of the compact for a magnet is 1 mm or more.

4. A magnetic member produced by compression-molding a rare earth-iron-nitrogen-based alloy powder containing a plurality of particles of a rare earth-iron-nitrogen-based alloy containing a rare earth element, iron, and nitrogen,
wherein the rare earth-iron-nitrogen-based alloy satisfies configurations (a) to (c) below and has 5% by volume or more and 20% by volume or less of voids formed therein:
(a) having a structure containing 10% by mass or more and 30% by mass or less of Sm, 10% by mass or less of Mn, 2% by mass or more and 7% by mass or less of nitrogen, and the balance consisting of Fe and inevitable impurities;
(b) a composition, Sm₂MnₓFe₁₇₋ₓN_{y} (x=0.1 or more and 2.5 or less, y=1.9 or more and 6.8 or less); and
(c) an average crystal grain diameter of 700 nm or less.

5. The magnetic member according to claim 4, wherein the coercive force is 635 kA/m or more.

6. A method for producing a compact for a magnet comprising:
a preparation step of preparing a rare earth-iron-based alloy flake containing a rare earth element and iron;
a grinding step of mechanically grinding the rare earth-iron-based alloy flake in an atmosphere with an oxygen concentration of 1% by volume or less to form a rare earth-iron-based alloy powder;
a hydrogenation step of hydrogenating the rare earth-iron-based alloy powder at a temperature equal to or higher than a disproportionation temperature in an atmosphere containing hydrogen to form a hydrogenated powder;
a molding step of compression-molding the hydrogenated powder under a pressure of 490 MPa or more to form a powder compact; and
a dehydrogenation step of dehydrogenating the powder compact at a temperature equal to or higher than a recombination temperature in an inert atmosphere or a reduced-pressure atmosphere to form a compact for a magnet,
wherein the rare earth-iron-based alloy has a structure containing 10% by mass or more and 30% by mass or less of Sm, 10% by mass or less of Mn, and the balance consisting of Fe and inevitable impurities, and the composition thereof is Sm₂MnₓFe₁₇₋ₓ (x=0.1 or more and 2.5 or less).

7. The method for producing a compact for a magnet according to claim 6,
wherein in the hydrogenated powder,
a phase of a Sm hydride and a phase of an iron-containing substance containing Mn and Fe are present adjacent to each other;
the phase of the Sm hydride contains SmH₂ and has a granular shape; and
the distance between the adjacent Sm hydride phases with the iron-containing substance phase disposed therebetween is 3 μm or less.

8. The method for producing a compact for a magnet according to claim 6, wherein the D50 particle diameter of the rare earth-iron-based alloy powder is 50 or more and 350 μm or less.

9. A method for producing a magnetic member comprising a nitriding step of nitriding a compact for a magnet produced by the method for producing a compact for a magnet according to claim 6 at a temperature equal to or higher than a nitriding temperature in an atmosphere containing nitrogen.

10. The method for producing a magnetic member according to claim 9, wherein the atmosphere containing nitrogen is any one of a NH₃ gas atmosphere, an atmosphere of mixed gas of NH₃ gas and H₂ gas, a N₂ gas atmosphere, and an atmosphere of mixed gas of N₂ gas and H₂ gas.

11. The method for producing a magnetic member according to claim 9, wherein the nitriding is performed at a temperature of 300° C. or more and 550° C. or less for a retention time of 10 min or more and 2000 min or less.
